(19) United States
(12) Patent Application Publication
(10) Pub. No.: US 2024/0263721 A1
(43) Pub. Date: Aug. 8, 2024

(54) PRESSURE PIPES WITH IMPROVED BARRIER PROPERTIES TO HYDROGEN GAS

(71) Applicant: National Industrialization Company (TASNEE), Riyadh (SA)

(72) Inventors: Hafid Boufersaoui, Jubail Industrial city (SA); Omer S. Al Jebreen, Dammam (SA); Sulaiman S. Al-Khattaf, Dhahran (SA)

(21) Appl. No.: 18/422,644

(22) Filed: Jan. 25, 2024

Related U.S. Application Data
(60) Provisional application No. 63/443,153, filed on Feb. 3, 2023.

(51) Int. Cl. F16L 9/12; C08K 5/092; C08K 5/56

(52) U.S. Cl. CPC F16L 9/12; C08K 5/092; C08K 5/56

(57) ABSTRACT

The present disclosure provides a composition, and pressure pipes produced therefrom, comprising a multimodal high-density polyethylene and from about 0.10% to about 0.30% nucleating agent to improve the barrier property of high-density polyethylene pressure pipes to hydrogen gas. The pressure pipes produced with this composition will convey hydrogen gas with reduced permeation rates in the range of about from 20% to about 40% compared to control high-density polyethylene pressure pipes made from the same multimodal high-density polyethylene that does not contain nucleating agent.

### INCORPORATION BY REFERENCE STATEMENT

This application claims priority to U.S. Provisional Application 63/443,153 filed Feb. 3, 2023, the entire contents being hereby expressly incorporated herein by reference.

### BACKGROUND OF THE DISCLOSURE

The following disclosure generally relates to a polyethylene composition and, more specifically, to a multimodal polyethylene material and nucleating agent for producing pipe having improved hydrogen gas barrier properties.

With current interest in development of renewable energy sources, hydrogen gas offers an economically attractive and eco-friendly solution. However, transportation and delivery of hydrogen from the production site to the end user remains an issue. Polyethylene (PE) pipe networks would be considered because of relatively low installation costs and ease of maintenance. However, the high operating pressure of hydrogen applications and the high permeability of hydrogen gas through high-density polyethylene (HDPE) pipe wall, present technical hurdles for its use.

Permeation measurements in a study conducted by R. J. M. Hermkens and H. A. Ophoff KIWA [I] using PE 100 pipes for hydrogen transportation found a hydrogen permeation coefficient of 126.8 (ml·mm)/(m²·bara·day) whereas for methane or natural gas the permeation coefficient is 56 (ml·mm)/(m²·bara·day). This can be expected because hydrogen molecules are very small, having a kinetic diameter 2.89 Å, compared to methane with a 3.80 Å diameter.

Another investigation by Mats Backman, Stenungsund, Henrik Iskov [2] on the vulnerability of polyethylene pipes exposed to hydrogen, i.e., polyethylene pipes, exposed polyethylene to 100% hydrogen for 4 years. The results reveal no adverse effect on either PE 80 pipes or on PE 100 in terms of performance, including mechanical, thermal, etc.

Another study conducted by Henrik Iskov and Stephan Kneck [3], PE 100 pipes were examined after 10 years of continuous hydrogen exposure. The subsequent laboratory tests based on international standards indicated no influence on the PE 100 gas pipes' durability.

High-density polyethylene (HDPE) pipes are the material of choice for many of these gas transportation applications. However, there is a need to improve the barrier properties of HDPE pressure pipes. Polymer development is needed to withstand such high pressures and provide good barrier properties. If new and existing polyethylene networks prove to be suitable for the distribution of hydrogen, this will likely offer new and economically interesting opportunities to transport excess renewable energy.

### SUMMARY OF THE DISCLOSURE

A method for improving the barrier properties of a multimodal high-density polyethylene (HDPE) pressure pipes used for gas transportation includes the following steps. A mixture comprising a multimodal high-density polyethylene (HDPE) and a nucleating agent is converted into a pressure polyethylene pipe. The HDPE has a melt flow rate within the range of 0.19 to 0.3 dg/min, and the nucleating agent comprises zinc stearate and 1,2-cyclohexanedicarboxylic acid, calcium salt as masterbatch. The pressure polyethylene pipe has at least a 20% up to 40% improvement of barrier properties to hydrogen gas compared with a control multimodal HDPE pressure polyethylene pipe which is made from the same multimodal HDPE but does not contain the nucleating agent.

In one embodiment, a mixture comprises a multimodal high-density polyethylene copolymer 1-butene and from about 0.10% to 0.30% of nucleating agent, wherein the nucleating agent comprises a mixture of zinc stearate and 1,2-cyclohexane dicarboxylic acid calcium salt. The nucleating agent can be added as a masterbatch or as neat components. In another embodiment, this mixture is used for manufacturing pressure polyethylene pipes used for hydrogen gas transportation.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. In the drawings:

FIGS. 1A and 1B compare the crystallization of polyethylene without a nucleating agent (FIG. 1A) to the crystallization with a nucleating agent (FIG. 1B). These pictures were taken by hot stage polarized light microscopy at 500×.

FIG. 2 is a graph comparing PE 2022-338 #1 pipe extruded with control material (without nucleating) and pipes extruded with PE 2022-339 #1 and PE 2022-339 #2, compositions comprising multimodal HDPE and nucleating agent. The results reveal a significant difference observed between the two types of pipes PE 2022-339 #1 and PE 2022-339 #2. Tests were conducted for 21 days.

### DETAILED DESCRIPTION OF EXEMPLARY EMBODIMENTS

Before explaining at least one embodiment of the present disclosure in detail, it is to be understood that the present disclosure is not limited in its application to the details of construction and the arrangement of the components or steps or methodologies set forth in the following description or illustrated in the drawings. The present disclosure is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the present disclosure shall have the meanings that are commonly understood by those of ordinary skill in the art. Further, unless otherwise required by context, singular terms shall include pluralities and plural terms shall include the singular.

All of the articles and/or methods disclosed herein can be made and executed without undue experimentation in light of the present disclosure. While the articles and methods of the present disclosure have been described in terms of preferred embodiments, it will be apparent to those skilled in the art that variations may be applied to the articles and/or methods and in the steps or in the sequence of steps of the method described herein without departing from the concept, spirit, and scope of the present disclosure. All such similar substitutes and modifications apparent to those skilled in the art are deemed to be within the spirit, scope, and concept of the present disclosure.

As utilized in accordance with the present disclosure, the following terms, unless otherwise indicated, shall be understood to have the following meanings:

The use of the word “a” or “an” when used in conjunction with the term “comprising” in the claims and/or the specification may mean “one”, but it is also consistent with the meaning of “one or more,” “at least one,” and “one or more than one.” The use of the term “or” in the claims is used to mean “and/or” unless explicitly indicated to refer to alternatives only or that the alternatives are mutually exclusive, although the disclosure supports a definition that refers to only alternatives and “and/or.”

Throughout this application, the term “about” is used to indicate that a value includes the inherent variation of error for the device, the method being employed to determine the value, or the variation that exists among the study subjects. For example, but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one of X, Y, and Z” will be understood to include X alone, Y alone, and Z alone, as well as any combination of X, Y, and Z. The use of ordinal number terminology (i.e., “first,” “second,” “third,” “fourth,” etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item.

The term “associate” as used herein will be understood to refer to the direct or indirect connection of two or more items.

In this disclosure, it can be seen that the use of a suitable nucleating agent with high-density polyethylene (HDPE) significantly improves the barrier property for hydrogen gas by reducing the permeation rate. This is interesting because the addition of nucleating agent to high-density polyethylene (HDPE) is uncommon because HDPE readily crystallizes without nucleating agent.

The present disclosure provides a composition, and pressure pipes produced therefrom, comprising a multimodal high-density polyethylene and from about 0.10% to about 0.30% nucleating agent to improve the barrier property of high-density polyethylene pressure pipes to hydrogen gas. The pressure pipes produced with this composition will convey hydrogen gas with reduced permeation rates in the range of about from 20% to about 40% compared to the control high-density polyethylene pressure pipes made from the same multimodal high-density polyethylene that does not contain nucleating agent

It is believed that addition of nucleating agent to polyethylene, semi-crystalline material, provides a large number of sites for growth upon cooling from a melt. When cooling polyethylene from molten state into solid form, the number of nuclei formed increases in a given time interval at a predetermined temperature. Polyethylene has both amorphous and crystalline regions, which makes the prediction of permeation properties complicated due to the presence of two distinct phases. The crystalline regions form polycrystalline aggregates, known as spherulites, and the overall crystallinity depends on the number of nuclei that are formed and also on the spherulite growth rate from such nuclei.

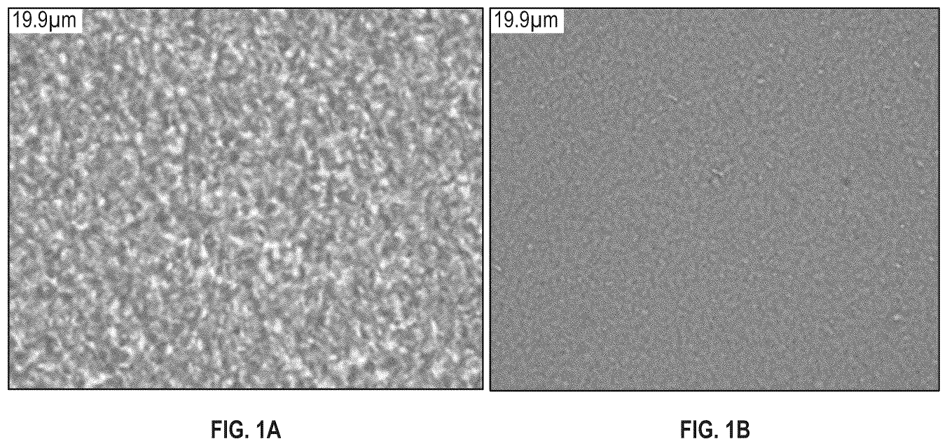

The small spherulites continue to grow until they impinge on adjacent spherulites. Subsequently, the free space is reduced. Thus, polyethylene pipes produced from nucleated compound material also have improved stiffness properties. FIGS. 1A and 1B show two different behaviors of pipes. FIG. 1A pipe is extruded with control material (without nucleating agent) and FIG. 1B shows pipe extruded with a composition comprising multimodal high-density polyethylene and a nucleating agent. The results reveal a significant difference observed between the two types of pipes. The test was conducted for 21 days

There are several factors that affect the permeability of polymers to hydrogen, including crystallinity, chain orientation, fillers, and side chain complexity. All of these properties affect the free volume available for molecular diffusion of permeant species. Free volume is defined as the unoccupied region included in the polymer volume that is accessible to polymer chain segmental motions. The presence of free volume enables molecular gas diffusion in that the diffusing species moves from one open “site” to another by chain movement into the free volume space. The available free volume can change drastically with minimal changes in polymer properties. In the presence of nucleating agent, which reduces spaces as mentioned above, and the increased stiffness will also reduce the mobility of the chain motion, creating torturous path. The morphological structure in which the crystalline units are arranged, affects the barrier properties of the polyethylene.

We have found that improved hydrogen gas barrier properties can be achieved with good dispersion and homogeneity of nucleated polyethylene in the matrix and with selected nucleating agent.

### EXAMPLE EXPERIMENTS

Multimodal polyethene material in pellet form was compounded with nucleating agent Hyperform HPN-20E commercially available from Milliken Chemical. Hyperform HPN-20E comprises, according to the SDS, 34% zinc stearate, and 66% 1,2-cyclohexanedicarboxylic acid and calcium salt. The final content of nucleating agent in the composition is in the range of 1000 ppm to 3000 ppm. This composition is suitable for producing HDPE pressure pipes with a permeation rate reduction in the range of 20% and 40% compared to the same multimodal polyethylene pressure pipes without nucleating agent.

### Compound Preparation Procedure

In this disclosure the nucleated compound, the process consists of two steps to achieve a good dispersion and good homogeneity. First step is to prepare a pre-compound comprising multimodal high-density polyethylene material mixed with about 0.50% to about 0.80% of nucleating agent, using Coperion twin screw extruder line. The second step is to add the pre-compound to neat multimodal high-density polyethylene material, to get the final composition comprising multimodal high-density polyethylene material about 0.10% up to about 0.30% of nucleating agent. Assessment of the physical and mechanical properties of the nucleated and non-nucleated compositions showed no significant changes. Some values are reported in Table 1 below.

TABLE 1
Example testing results of control material and nucleated material

| | | Control | Multimodal HDPE |
|---|---|---|---|
| | | Multimodal | with Nucleating |
| No. | Properties | HDPE | Agent |
| 1 | MFR @ 5 kg, dg/min | 0.20-0.30 | 0.20-0.30 |
| 2 | Density, g/cm³ | 0.956-0.961 | 0.956-0.961 |
| 3 | OIT @ 210° C., min | 60 | 60 |
| 4 | Charpy @ 23° C., KJ/m² | 29.02 | 21.45 |
| 5 | Yield stress, MPa | 23 | 23 |
| 6 | Yield strain, MPa | 10 | 9 |
| 7 | Chord modulus, MPa | 979 | 965 |
| 8 | Tensile creep @ 24 hr, MPa | 1370 | 1310 |
| 9 | Hydrostatic pressure tests | >100 hours | >100 hours |
| | 20° C./12.0 MPa ISO4437 | | |

In the final step, the compound comprising multimodal HDPE material with 0.10% to 0.30% of nucleating agent and control multimodal HDPE, having a melt flow rate (MFR) of from 0.20 dg/min to 0.30 dg/min according to ISO 1133, and density of 0.956 g/cm³ to 0.970 g/cm³ according to ISO 1183, were extruded into pressure pipes. Pipe diameter produced is 32 mm/SDR11 using a KraussMaffei single screw extruder.

The extruded pipes were tested for hydrostatic creep tests with conditions of 20° C. and applied stress of 12.0 MPa. As can be seen from Table 1, both pipe compositions passed more than 100 hours according to ISO 4437-2.

### Hydrogen Permeation Pipe Testing Procedure

Tests were conducted in external laboratory to perform the hydrogen permeation testing. The setup consisted of one steel jacket pipe to accommodate the polyethylene diameter pipe. Polyethylene pipe is installed in the steel pipe jacket and closed with sealed end caps. The steel jacket pipe is filled with 100% of nitrogen and the polyethylene pipe is filled with 100% of hydrogen dry and more than 99% of purity. Over time, the hydrogen will permeate the polyethylene pipe wall and reach a steady state. The hydrogen gas from the plastic pipe is accumulated in the steel jacket pipe. The permeation rate testing was performed under high operational pressure of 6.3 bars(g) and temperature 23° C. The concentration of hydrogen gas is measured in the jacket steel pipe over time by using gas chromatography technique. The permeation coefficient for hydrogen gas is then calculated using the formula in EQ. 1 explained below.

Testing was conducted on polyethylene pipe with diameter 32.0-32.3 mm and thickness of 3.0 to 3.4 mm reached a steady-state within a few weeks, therefore measurements started and lasted for three weeks. Another regular pipe made from the same polyethylene material but without nucleating agent was used as a control sample for the same experimental permeation tests. The 32 mm diameter pipes were used due to the advantage of narrow wall thickness range from 3.0 mm to 3.3 mm, to shorten the test time duration for the permeation tests.

The polyethylene pipes tested were smooth without scratches on the surface and no defects to avoided complicating the test significantly. Leak tight connection between the end caps and pipe was ensured. Tests are applied for both types of polyethylene pipes, having compositions with and without nucleating agent.

The relationship between the permeation rate and the permeation coefficient (PC) is linear, and is given by the following formula:

$$PC = ( QP \times e ) / ( A \times Δ p ) \qquad EQ . 1$$

wherein:
PC=Permeation Coefficient, (ml·mm)/(m²·bara·day)
QP=Permeated Volume, ml/day
e=Wall thickness, mm
Δp=difference in partial pressure (absolute), bara
A=area of the pipe, m² (the area is calculated by using the average of the inner and outer diameter, and the length of the pipe)

The PC of the material can be used to calculate the volume loss of the total pipe by permeation using the following formula:

$$QP = ( PC \times π \times ( SDR - 1 ) \times L \times Δ p ) / 1000 \qquad EQ . 2$$

### Pipe Testing Procedure

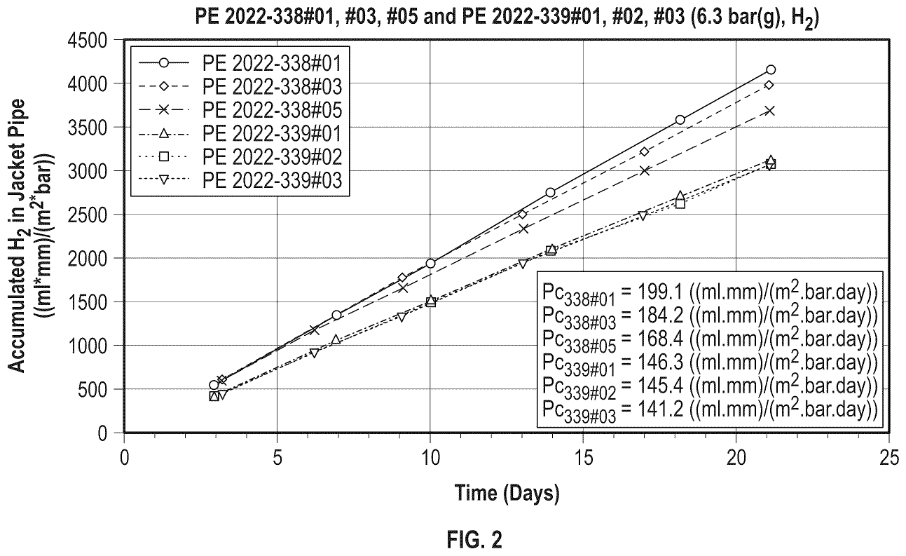

Tests were conducted in the laboratory by KIWA Netherland for 21 days on polyethylene pipe with diameter in range of 32.0 mm to 32.3 mm and thickness of 3.0 mm to 3.4 mm. The results showed a significant reduction of hydrogen permeation rate with compositions having about 0.10% to about 0.30% of nucleating agent compared to compositions without nucleating agent. The percentage reduction in the permeation rate was in a range of 20% to 40%. Subsequently, the permeation coefficients show the significant improvement, i.e., more than 28% reduction compared to control and regular samples as shown in FIG. 2.

### REFERENCES

[1] MODERN PE PIPE ENABLES THE TRANSPORT OF HYDROGEN—R. J. M. Hermkens, H. Colmer, and H. A. Ophoff, Proceedings of the 19^{th} Plastic Pipes Conference PPXIX, Sep. 24-26, 2018, Las Vegas, Nevada, U.S.A.
[2] TRANSPORT OF HYDROGEN WITH POLYETHYLENE NATURAL GAS PIPES, Mats Backman, and Henrik Iskov, PPCA, #2010 Vancouver.
[3] USING THE NATURAL GAS NETWORK FOR TRANSPORTING HYDROGEN—TEN YEARS OF EXPERIENCE, Henrik Iskov and Stephan Kneck, Proceedings of the International Gas Union Research Conference 2017, Rio de Janeiro.

What is claimed is:

1. A method for improving the barrier properties of a multimodal high-density polyethylene (HDPE) pressure pipes used for gas transportation, the method comprising:
converting into a pressure polyethylene pipe, a mixture comprising a multimodal high-density polyethylene (HDPE) and a nucleating agent, wherein the HDPE has a melt flow rate within the range of 0.19 to 0.3 dg/min, and the nucleating agent comprises zinc stearate and 1,2-cyclohexanedicarboxylic acid calcium salt as a masterbatch; and
wherein the pressure polyethylene pipe has at least a 20% up to 40% improvement of barrier properties to hydrogen gas compared with a control multimodal HDPE pressure polyethylene pipe which is made from the same multimodal HDPE but does not contain the nucleating agent.

2. The method of claim 1, wherein the multimodal HDPE is a 1-butene copolymer having a melt flow rate (MFR) at 5 Kg/190° C. within a range of about 0.19 to 0.30 dg/min is used for manufacturing pressure polyethylene pipes having an improvement of 20% to 40% of the hydrogen gas barrier property.

3. The method of claim 1, wherein the multimodal HDPE comprises a 1-butene copolymer has density within the range of 0.0.940 to 0.970 g/cm3 used for manufacturing the pressure polyethylene pipes having an improvement of 20% to 40% of the hydrogen barrier property.

4. A mixture comprising a multimodal high-density polyethylene copolymer 1-butene and from about 0.10% to 0.30% of nucleating agent, the nucleating agent comprising a mixture of zinc stearate and 1,2-cyclohexane dicarboxylic acid calcium salt, the nucleating agent added as a masterbatch or as neat components.

5. Using the mixture of claim 4 for manufacturing pressure polyethylene pipes used for hydrogen gas transportation.

6. Pressure polyethylene pipe comprising the composition of claim 4.
